(19) United States
(12) Patent Application Publication
(10) Pub. No.: US 2011/0054759 A1
(43) Pub. Date: Mar. 3, 2011

(54) METHOD FOR CHECKING THE PLAUSIBILITY OF A TEMPERATURE VALUE IN AN INTERNAL COMBUSTION ENGINE

(76) Inventor: Gerhard Eser, Hemau (DE)

(21) Appl. No.: 12/863,391

(22) PCT Filed: Dec. 17, 2008
(86) PCT No.: PCT/EP2008/067720

§ 371 Date: Jul. 16, 2010

(30) Foreign Application Priority Data
Jan. 16, 2008 (DE) 10 2008 004 706.6

(51) Int. Cl. G06G 7/70; G06F 15/00

(52) U.S. Cl. 701/101; 702/130

(57) ABSTRACT

A method for checking the plausibility of a temperature value in an internal combustion engine has the following steps: ascertaining a measurement value (TCO) of the temperature value, ascertaining a model value (TCO_SUB) of the temperature value, comparing the measurement value (TCO) and/or the model value (TCO_SUB) to at least one threshold value (TCOMAX), determining the plausibility of the temperature value as a function of the comparison, and defining the threshold value (TCOMAX) as a function of the temperature value in the internal combustion engine.

### CROSS-REFERENCE TO RELATED APPLICATIONS

This application is a U.S. National Stage Application of International Application No. PCT/EP2008/067720 filed Dec. 17, 2008, which designates the United States of America, and claims priority to German Application No. 10 2008 004 706.6 filed Jan. 16, 2008, the contents of which are hereby incorporated by reference in their entirety.

### TECHNICAL FIELD

The invention relates to a method for checking the plausibility of a temperature value in an internal combustion engine.

### BACKGROUND

Internal combustion engines (e.g. Otto engines and diesel engines) exhibit a temperature-dependent loss torque as a result of their internal friction, with the loss torque reducing degressively with the engine temperature. This means that internal combustion engines exhibit a relatively large loss torque after a cold start at low engine temperature, while the loss torque after the operating temperature of the internal combustion engine is reached is significantly lower.

With modern internal combustion engines the engine temperature is therefore typically ascertained by measuring the coolant temperature or the oil temperature using a temperature sensor. The temperature-dependent loss torque of the internal combustion engine is then calculated from the measurement value of the engine temperature on the basis of the known physical relationship between the loss torque and the engine temperature. The temperature-dependent loss torque of the internal combustion engine is then taken into account when controlling the internal combustion engine.

It is problematic in such cases that a malfunction of the temperature measurement causes an incorrect loss torque to be calculated, which leads to incorrect control of the internal combustion engine. If for example, as a result of a measurement error, too great a loss torque of the internal combustion engine is calculated, the Electronic Control Unit (ECU) causes an undesired acceleration of the motor vehicle in order to compensate for the supposed loss torque.

Because of this importance of correct temperature measurement for the correct operation of the internal combustion engine there are statutory requirements for the plausibility of the measured engine temperature to be monitored, in order to detect an incorrect temperature measurement.

With conventional internal combustion engines, according to various embodiments of this plausibility checking, not only is one measurement value of the temperature value of interest (e.g. coolant temperature, oil temperature) ascertained, but also a model value of the temperature value, with the model value being determined on the basis of a technical-physical model of the internal combustion engine. Subsequently the measurement value is then compared to a predetermined temperature-independent minimum value while the model value is compared with a likewise predetermined temperature-independent maximum value. If the measurement value of the minimum value is undershot and the model value exceeds the maximum value an error of the temperature measurement is assumed and a corresponding error flag is set. Otherwise a correct temperature measurement is concluded according to various embodiments of the plausibility checking.

The disadvantage of the known method for plausibility checking of a temperature measurement described here is the fact that ambient conditions are not taken into account during the plausibility checking since the limit values (maximum value, minimum value) are predetermined as fixed values.

A method for diagnosis of the coolant water thermostat or the associated temperature sensor is known from DE 199 58 385 A1 in which the loss torque of the internal combustion engine is taken into account by the temperature being deduced from the loss torque. In addition this publication discloses a plausibility check in which a comparison of modeled and measured temperature values is undertaken. It is not known from this publication however that model value and measurement value of the temperature are each compared to a limit value respectively.

A method for plausibility checking during a temperature measurement in an internal combustion engine is also known from DE 10 2004 048 078 A1. Here too a model value is compared to a measurement value of the temperature to be ascertained in order to detect an error. However this publication too does not disclose that temperature value and model value are each compared with a respective limit value.

### SUMMARY

According to various embodiments, the known method described here for checking the plausibility of a temperature measurement can be improved.

According to various embodiments, a method for plausibility checking of a temperature value in an internal combustion engine, may comprise the following steps: a) Ascertaining a measurement value of the temperature value, b) Ascertaining a model value of the temperature value, c) Comparing the measurement value and/or the model value with at least one limit value, d) Determining the plausibility of the temperature value depending on the comparison, and e) Defining the limit value as a function of the measurement value and/or the model value of the temperature value of the internal combustion engine.

According to a further embodiment, the method may comprise the following step: Ascertaining a temperature-dependent torque loss of the internal combustion engine as a function of the temperature value of the internal combustion engine. According to a further embodiment, the method may comprise the following step: Controlling the internal combustion engine as a function of the temperature-dependent torque loss. According to a further embodiment, the method may comprise the following steps: a) Predetermining a maximum value for a torque difference between the torque loss for the model value and the torque loss for the measurement value of the temperature value, b) Defining the limit value for the plausibility checking as a function of the predetermined maximum value of the torque difference. According to a further embodiment, a) A maximum value can be specified as a function of the temperature value for the model value, b) Depending on the temperature value a minimum value can be specified for the model value, c) The model value can be compared to the maximum value, and d) The model value can be compared to the minimum value. According to a further embodiment, a) depending on the temperature value a maximum value can be defined for the measurement value, b) depending on the temperature value a minimum value can be defined for the measurement value, c) the measurement value can be compared to the maximum value, d) the measurement value can be compared to the minimum value. According to a further embodiment, the temperature value may reflect one of the following temperatures of the internal combustion engine: a) Coolant temperature, b) Oil temperature, and c) Cylinder head temperature. According to a further embodiment, the method may comprise the following step: Switching over the internal combustion engine to an emergency operating mode if the plausibility check produces an implausible temperature value. According to a further embodiment, for controlling the internal combustion engine in an emergency operating mode, the model value may be taken into account instead of the measurement value.

According to another embodiment, an engine control unit for controlling an internal combustion engine, may execute the method as described above.

According to yet another embodiment, a computer program product may store a control program, wherein the control program is able to be executed in an electronic engine control of an internal combustion engine and being able to execute a method as described above during an execution.

According to a further embodiment of the computer program product, the computer program product may be one of the following storage media: a) Diskette, b) CD, c) DVD, and d) Semiconductor memory.

### BRIEF DESCRIPTION OF THE DRAWINGS

Other embodiments will be explained below together with the description of exemplary embodiments with reference to the drawings. The figures show:

FIG. 1 a characteristic curve which reproduces the relationship between the coolant temperature of an internal combustion engine and the resulting loss torque of the internal combustion engine, with the diagram showing a temperature measurement at operating temperature;

FIG. 2 the characteristic curve from FIG. 1, with a temperature measurement after a cold start being shown,

FIGS. 3 to 6 different flow diagrams with procedures which can be executed within the framework of the plausibility checking according to various embodiments, as well as

FIG. 7 a flow diagram which shows how the result of the plausibility checking is taken into account during operation of the internal combustion engine.

### DETAILED DESCRIPTION

According to various embodiments, measurement errors of the engine temperature lead to a temperature-dependent torque error in the determination of the loss torque, with the dependence between the torque error and the underlying temperature measurement error being degressive. This means that at low engine temperatures a relatively small temperature measurement error already leads to a relatively large torque error when the torque loss is being determined, since the characteristic curve which reflects the dependency between the torque loss and the engine temperature has a steeper gradient at lower temperatures. At high engine temperatures (e.g. at operating temperature) on the other hand this curve is flat so that the same temperature measurement error leads to a significantly smaller torque error.

According to various embodiments, the general technical teaching of providing variable limit values can be included, which are typically determined as a function of the engine temperature, according to various embodiments of the plausibility checking of the temperature measurement instead of rigid temperature-independent limit values.

According to various embodiments, for checking the plausibility a measurement value of the temperature value of interest (e.g. coolant temperature, oil temperature) of the internal combustion engine is likewise ascertained. The temperature sensors which are provided in any event in modern motor vehicles and measure the coolant temperature or the oil temperature can typically be used for this purpose.

In addition a model value of the same temperature value is ascertained according to various embodiments, with the model value being ascertained in the conventional manner using a technical-physical model.

The measurement value and/or the model value are then compared with at least one limit value in order to enable the plausibility of the temperature value to be specified as a function of the comparison.

It is important according to various embodiments for at least one of the limit values not to be rigidly predetermined, but to be defined flexibly as a function of the temperature of the internal combustion engine.

According to an embodiment, the limit value is defined as a function of the measurement value of the temperature value. According to another embodiment, the limit value is defined instead as a function of the model value of the temperature value.

In addition there is the option according to various embodiments for the measurement value to be defined as a function of the model value and as a function of the measurement value. For example the limit value can be defined as a function of the average of the measured value and the model value.

In addition the method according to various embodiments preferably can also make provision for the temperature-dependent loss torque to be ascertained as a function of the temperature value of the internal combustion engine, which is possible on the basis of the known relationships between the engine temperature and the resulting loss torque.

The internal combustion engine can then be controlled according to various embodiments as a function of the temperature-dependent loss torque.

In an exemplary embodiment, a maximum value for a torque difference between the loss torque for the model value and the loss torque for the measurement value of the temperature value is predetermined. The maximum value of the torque difference thus reflects the maximum tolerable torque error for temperature-dependent ascertainment of the loss torque.

The limit value for plausibility checking is then determined as a function of the predetermined maximum value of the torque difference. Preferably the limit value for the plausibility checking is thus not only defined as a function of the engine temperature but also as a function of the torque error that can be tolerated.

According to an embodiment, not just a single limit value but a maximum value and a minimum value are specified as a function of temperature value. The model value is then preferably compared to the maximum value and the minimum value. In addition, in the above embodiment, a minimum value and a maximum value are also preferably determined for the measurement value, with the measurement value being compared to the maximum value and the minimum value.

In the evaluation of the comparison between the model value or the measurement value respectively on the one hand and the maximum value or the minimum value on the other hand, different logical combinations are possible. For example a measurement error can be assumed if the model value either exceeds the maximum value or undershoots the minimum value, provided the measurement value simultaneously exceeds the maximum value or undershoots the minimum value.

It has already been mentioned that the temperature value of the internal combustion engine can involve the coolant temperature or the oil temperature. The invention is however not restricted in respect of the temperature value of the internal combustion engine to the examples given here but can also be realized with other temperature values of the internal combustion engine, such as the cylinder head temperature for example. The decisive factor is merely that the temperature value influences the loss torque of the internal combustion engine.

Depending on the result of the plausibility checking, the operation of the internal combustion engine can then be influenced according to various embodiments. For example there can be a switchover to emergency operation if the plausibility checking produces an implausible temperature value. In this emergency operation the model value instead of the measurement value can be taken into account in the control of the internal combustion engine. If the plausibility checking of the temperature measurement on the other hand produces a plausible temperature measurement value, the internal combustion engine is preferably operated normally in which the measurement value of the temperature value is preferably included for controlling the internal combustion engine.

It should also be mentioned that the invention is not restricted to the method described here but also comprises an electronic engine control unit which executes the method.

The invention for also includes program storage (e.g. diskette, CD, DVD, hard disk, semiconductor memory), in which a control program is stored which executes the method when the program is run in the electronic engine control unit.

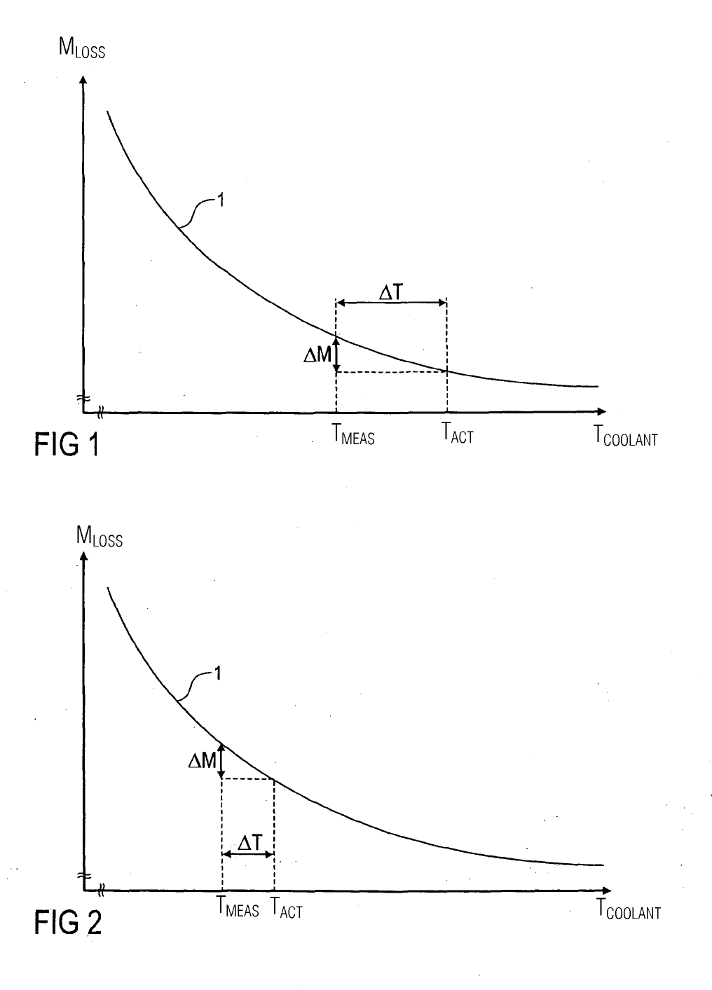

FIGS. 1 and 2 show a characteristic curve 1 in schematic form which shows the dependence of a loss torque M_{LOSS} of an internal combustion engine on a coolant temperature T_{COOLANT} of the internal combustion engine. It can be seen from this that the characteristic curve 1 exhibits a degressive temperature dependency. This means that temperature changes at a relatively high coolant temperature T_{COOLANT}, as in FIG. 1, have a relatively small influence on the resulting torque loss M_{LOSS}, while temperature changes at relatively small coolant temperatures T_{COOLANT}, as in FIG. 2, have a relatively large influence on the resulting torque loss M_{LOSS}.

Thus each of the two figures shows a temperature measurement value T_{MEAS} and an actual temperature value T_{ACT} as well as an associated temperature measurement error ΔT and a resulting torque error ΔM.

If a maximum value ΔM_{MAX} for the tolerable torque error ΔM is now predetermined, the maximum tolerable temperature measurement error ΔT depends on the coolant temperature T_{COOLANT}. Thus at operating temperature, as in FIG. 1, a relatively large temperature measurement error ΔT can be tolerated, while the tolerable temperature measurement error for a cold start as in FIG. 2 is significantly lower.

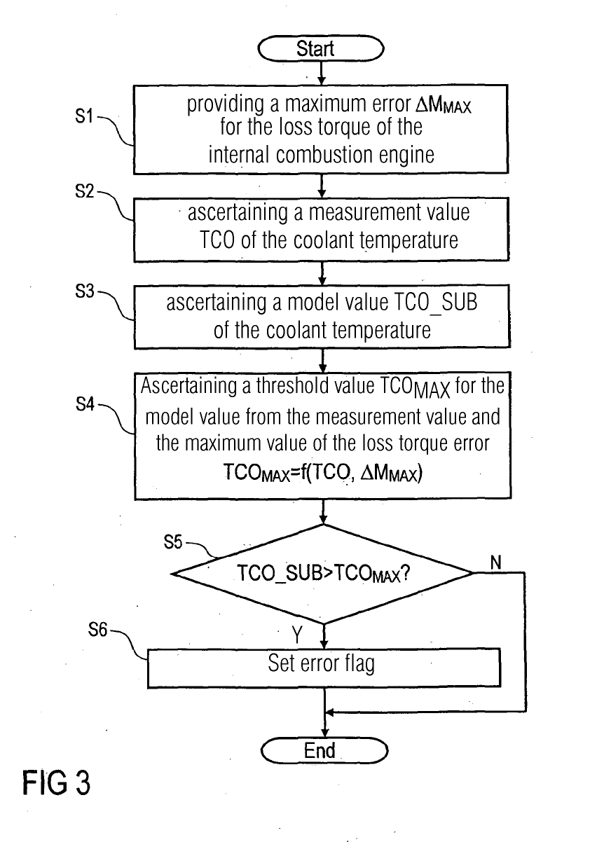

A test procedure is now described below on the basis of the flow diagram in FIG. 3, which is executed according to various embodiments for plausibility checking.

In a first step S1 the maximum value ΔM_{MAX} for the loss torque M_{LOSS} is initially predetermined for the internal combustion engine.

Subsequently, in a step S2, a measurement value TCO (TCO: Temperature Coolant Outlet) of the coolant temperature T_{COOLANT} is measured, for which purpose a conventional temperature sensor is used.

In a further step S3, on the basis of a technical-physical model, a model value TCO_SUB of the coolant temperature T_{COOLANT} is then ascertained, which can be done in a conventional manner and thus does not have to be described in any greater detail.

In a step S4 a limit value TCO_{MAX} for the model value TCO_SUB is then ascertained from the measurement value TCO and the maximum value ΔM_{MAX} in accordance with the following formula:

TCO_{MAX}=f (TCO, ΔM_{MAX})

In a further step S5 a comparison is then made as to whether the model value TCO_SUB exceeds the maximum value TCO_{MAX}.

If it does, an error flag is then set in a step S6.

If it does not, the step S6 is skipped instead and the test procedure is ended.

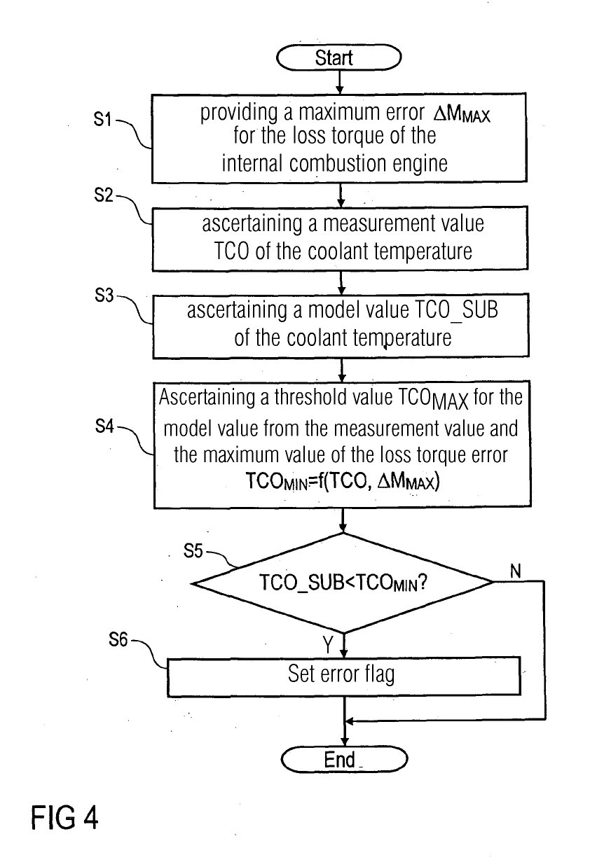

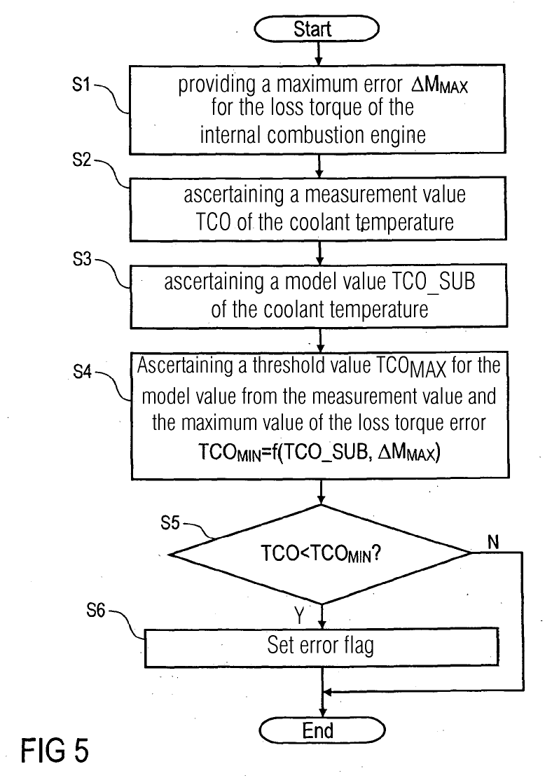

The flow diagrams in FIGS. 4 to 6 largely match the flow diagram described in accordance with FIG. 3, so that the reader is referred to the description above to avoid any repetition.

A special feature of the exemplary embodiment in accordance with FIG. 4 is that a minimum value TCO_{MIN} is ascertained for the model value TCO_SUB.

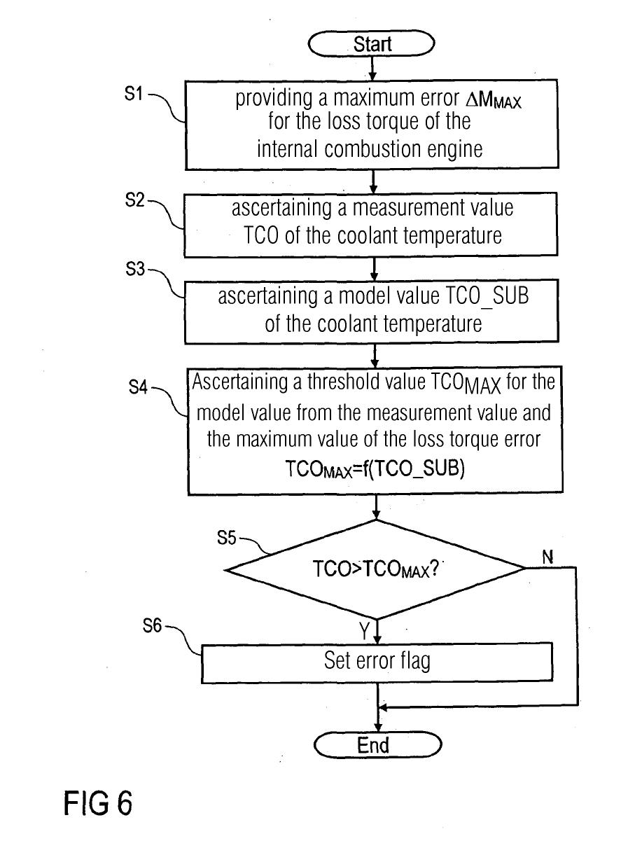

A special feature of the test procedures in FIGS. 5 and 6 is that it is not the model value TCO_SUB which is compared with a limit value but the measurement value TCO. In FIG. 5 a comparison is made here between the measurement value TCO and a minimum value TCO_{MIN}, while in FIG. 6 a comparison is made between the measurement value TCO and a maximum value TCO_{MAX}.

The test procedures described here in accordance with FIGS. 3 to 6 can be executed consecutively according to various embodiments for plausibility checking, with the error flags set in step 6 in each case able to be logically combined with one another. For example a system error of temperature measurement can be assumed if at least one single error flag is set. Alternatively the option exists of a system error of temperature measurement only being assumed if a number of error flags are set.

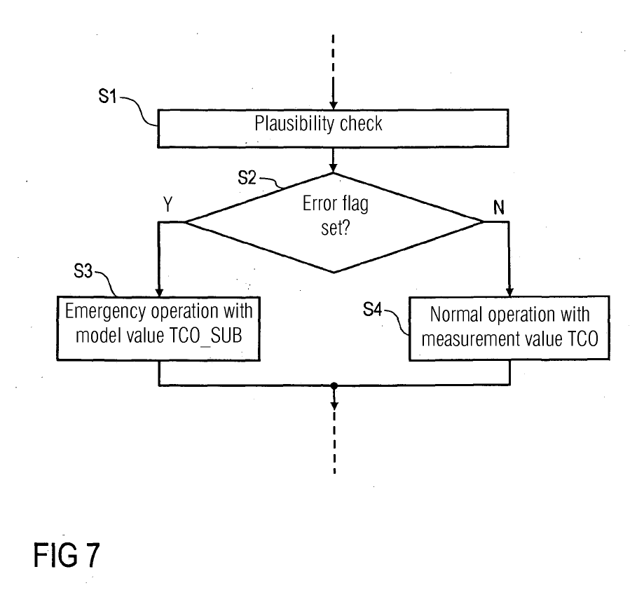

Finally FIG. 7 shows how the result of the plausibility checking is taken into account during operation of the internal combustion engine.

Thus, in a step S1 the plausibility checking according to various embodiments described here is initially undertaken.

In a step S2 a check is then made as to whether an error flag is set.

If this is the case, in a step S3 emergency operation of the internal combustion engine is started, in which the model value TCO_SUB is taken into account in the control of the internal combustion engine.

Otherwise, in a step S4, normal operation of the internal combustion engine is undertaken with the measurement value TCO.

The invention is not restricted to the exemplary embodiments described here. Instead a plurality of variants and derivatives are possible which likewise make use of the inventive idea and thus fall within the scope of protection.

What is claimed is:

1. A method for plausibility checking of a temperature value in an internal combustion engine, comprising:
a) Ascertaining a measurement value of the temperature value,
b) Ascertaining a model value of the temperature value,
c) Comparing at least one of the measurement value and/or the model value with at least one limit value,
d) Determining the plausibility of the temperature value depending on the comparison, and
e) Defining the limit value as a function of at least one of the measurement value and/or the model value of the temperature value of the internal combustion engine.

2. The method according to claim 1, comprising
Ascertaining a temperature-dependent torque loss of the internal combustion engine as a function of the temperature value of the internal combustion engine.

3. The method according to claim 2, comprising
Controlling the internal combustion engine as a function of the temperature-dependent torque loss.

4. The method according to claim 1, comprising
a) Predetermining a maximum value for a torque difference between the torque loss for the model value and the torque loss for the measurement value of the temperature value, and
b) Defining the limit value for the plausibility checking as a function of the predetermined maximum value of the torque difference.

5. The method according to claim 1, wherein
a) A maximum value is specified as a function of the temperature value for the model value,
b) Depending on the temperature value a minimum value is specified for the model value,
c) The model value is compared to the maximum value, and
d) The model value is compared to the minimum value.

6. The method according to claim 1, wherein
a) depending on the temperature value a maximum value is defined for the measurement value,
b) depending on the temperature value a minimum value is defined for the measurement value,
c) the measurement value is compared to the maximum value,
d) the measurement value is compared to the minimum value.

7. The method according to claim 1, wherein
the temperature value reflects one of the following temperatures of the internal combustion engine:
a) Coolant temperature,
b) Oil temperature,
c) Cylinder head temperature.

8. The method according to claim 1, comprising
Switching over the internal combustion engine to an emergency operating mode if the plausibility check produces an implausible temperature value.

9. The method according to claim 8, wherein
for controlling the internal combustion engine in an emergency operating mode, the model value is taken into account instead of the measurement value.

10. An engine control unit for controlling an internal combustion engine, with the engine control unit being configured to:
ascertain a measurement value of the temperature value,
ascertain a model value of the temperature value,
compare at least one of the measurement value and/or the model value with at least one limit value,
determine the plausibility of the temperature value depending on the comparison, and
define the limit value as a function of at least one of the measurement value and/or the model value of the temperature value of the internal combustion engine.

11. A computer program product with a control program stored thereon, with the control program able to be executed in an electronic engine control of an internal combustion engine and being able to execute a method according to claim 1 during an execution.

12. The computer program product according to claim 11, wherein
the computer program product is selected form the group consisting of the following storage media:
a) Diskette,
b) CD,
c) DVD, and
d) Semiconductor memory.

13. The engine control unit according to claim 10, wherein the engine control unit is further configured to ascertain a temperature-dependent torque loss of the internal combustion engine as a function of the temperature value of the internal combustion engine.

14. The engine control unit according to claim 13, wherein the engine control unit is further configured to control the internal combustion engine as a function of the temperature-dependent torque loss.

15. The engine control unit according to claim 10, wherein the engine control unit is further configured to
predetermine a maximum value for a torque difference between the torque loss for the model value and the torque loss for the measurement value of the temperature value, and
define the limit value for the plausibility checking as a function of the predetermined maximum value of the torque difference.

16. The engine control unit according to claim 10, wherein the engine control unit is further configured to specify a maximum value as a function of the temperature value for the model value,
depending on the temperature value, to specify a minimum value for the model value,
compare the model value to the maximum value, and
to compare the model value to the minimum value.

17. The engine control unit according to claim 10, wherein the engine control unit is further configured to define a maximum value for the measurement value depending on the temperature value, to define a minimum value for the measurement value depending on the temperature value, to compare the measurement value to the maximum value, and to compare the measurement value to the minimum value.

18. The engine control unit according to claim 10, wherein the temperature value reflects one of the following temperatures of the internal combustion engine:
a) Coolant temperature,
b) Oil temperature, and
c) Cylinder head temperature.

19. The engine control unit according to claim 10, wherein the engine control unit is further configured to switch over the internal combustion engine to an emergency operating mode if the plausibility check produces an implausible temperature value.

20. The engine control unit according to claim 19, wherein for controlling the internal combustion engine in an emergency operating mode, the model value is taken into account instead of the measurement value.
